(19) United States
(12) Patent Application Publication
(10) Pub. No.: US 2014/0360437 A1
(43) Pub. Date: Dec. 11, 2014

(54) COLLAPSIBLE CAT LITTER BOX

(71) Applicant: Jiangsu Zhongheng Pet Articles Joint-Stock Co.,Ltd, Jiangsu (CN)

(72) Inventor: Bin QIU, Jiangsu (CN)

(21) Appl. No.: 14/298,063

(22) Filed: Jun. 6, 2014

(30) Foreign Application Priority Data
Jun. 6, 2013 (CN) 201320352398.6

(51) Int. Cl. A01K 1/01

(52) U.S. Cl. CPC A01K 1/0125
USPC 119/165

(57) ABSTRACT

A collapsible cat litter box includes a top cover and a bottom basin. The bottom basin is fixable to the top cover by screws and nuts. The bottom basin and the top cover are provided with holes cooperating with the screws and nuts. Two screw-holes are provided at each of two ends of the bottom basin and two screw-holes are provided at each of two ends of the top cover. The top cover is provided with an opening for a cat to enter and exit. A body of the top cover is collapsible. The top cover is made of a blow-molded material.

### CROSS REFERENCE TO RELATED APPLICATION

The present application is based on, and claims priority from, Chinese Application Number 201320352398.6, filed Jun. 6, 2013, the disclosure of which is incorporated herein in its entirety.

### TECHNICAL FIELD

This disclosure relates to a pet cat product and, in particular, to a collapsible cat litter box.

### BACKGROUND

As society develops and living standards rise, people are not only enjoying material living but also in continuous pursuit of a spiritual life, and the keeping of pets is gradually becoming a popular fashion. Pets are occupying an ever higher position in people's lives, and people are demanding an ever higher quality of life for their pets. Owing to limitations on living environments, the problem of pet cats' excretions has always troubled pet lovers. Most existing cat litter boxes are in the form of boxes, with a large volume and high production costs, and are difficult to dismantle, fold, store and transport, while the cost of transport is also increased. In response to these problems, many pet lovers have made improvements in many areas, but despite having made a certain degree of progress, all have been unable to thoroughly resolve this problem.

### BRIEF DESCRIPTION OF DRAWINGS

The following drawings are illustrative of particular embodiments of the present disclosure. The drawings are not necessarily to scale (unless so stated) and are intended for use in conjunction with the explanations in the following detailed description. Embodiments of the invention will hereinafter be described in conjunction with the appended drawings.

FIG. 1 is a schematic diagram showing a collapsible cat litter box according to an embodiment of the present disclosure.

FIG. 2 is a schematic diagram showing the collapsible cat litter box according to an embodiment of the present disclosure in a disassembled state that the top cover, bottom basin and components are separated from each other.

FIG. 3 is a schematic diagram of the collapsible cat litter box according to an embodiment of the present disclosure with the top cover in a collapsed state and placed inside the bottom basin.

### DETAILED DESCRIPTION

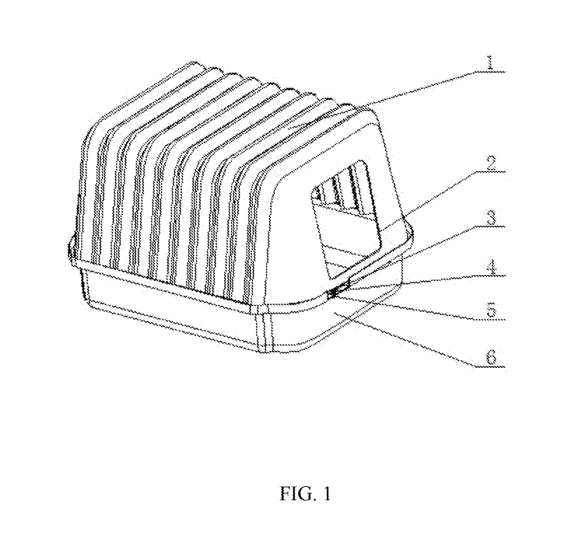

FIG. 1 shows a collapsible cat litter box according to an embodiment of the present disclosure. As illustrated in FIG. 1, the cat litter box includes a top cover 1 and a bottom basin 6 coupled with the top cover 1 from below in a vertical direction. The cat litter box is a substantially rectangular shape having a longitudinal direction and a transverse direction transverse to the longitudinal direction. The top cover 1 has a lower edge shape that matches the bottom basin 6. The top cover 1 is secured to the bottom basin 6 through screw connections which will be described in detail herein. In at least some embodiments, the screw connections are optional. The top cover 1 is provided with an opening 2 for a cat to enter and exit.

In one or more embodiments, the top cover 1 is made from a blow-molded plastic material. The top cover 1 as shown in FIG. 1 includes a body which is collapsible in the longitudinal direction. In the embodiment of FIG. 1, the body of the top cover 1 has an opening at an end of the top cover 1 in the longitudinal direction for a cat to enter and exit the cat litter box. The body of the top cover 1 includes a plurality of grooves extending from one edge of the body to another opposite edge of the body in the transverse direction. The grooves are adjacent each other in the longitudinal direction. The body of the top cover 1 further includes a plurality of ridges extending from the one edge of the body to the another opposite edge of the body in the transverse direction. Each of the grooves is formed between two adjacent ridges in the longitudinal direction. When the top cover 1 is collapsed, the ridges are compressed toward each other.

The bottom basin 6 is configured to store cat litter. The bottom basin 6 has an edge portion protruding outwardly of the bottom basin 6 and configured to receive an edge portion of the top cover 1 when the bottom basin 6 is coupled with the top cover 1.

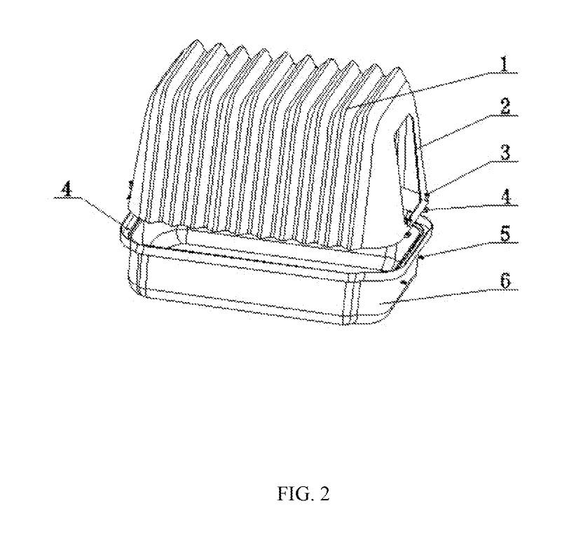

FIG. 2 shows the collapsible cat litter box according to an embodiment of the present disclosure in a disassembled state such that the top cover 1, bottom basin 6 and other components are separated from each other. As shown in FIG. 1, the top cover 1, at a periphery thereof, includes two screw-holes 4. In one embodiment, the two screw-holes are formed on each of two ends opposing each other in the longitudinal direction or in the transverse direction. The embodiment as shown in FIG. 2 has the two screw holes 4 formed on the opposing ends in the longitudinal direction. The bottom basin 6 is provided with two screw-holes 4 on the opposing ends in the longitudinal direction. The positions of the screw-holes 4 of the bottom basin coincide with the positions of the two screw-holes 4 of the top cover 1, respectively. The cat litter box is further provided with a set of screws 3 and nuts 5 as shown in FIG. 2. Specifically, when the top cover 1 is connected to the bottom basin 6, the screw 3 is inserted into the screw-hole 4 of the top cover 1 and the corresponding screw-hole 4 of the bottom basin 6, and then the top cover 1 is fixed to the bottom basin 6 by fitting the nut 5 onto the screw 3.

The bottom basin 6 is configured to store cat litter. A user can unscrew the two screws on the two ends of the bottom basin so that the top cover is separated from the bottom basin for adding or replacing cat litter in the bottom basin. In general, cat litter forms hard lumps after contacting with feces and urine and the hard lumps of the cat litter may be conveniently removed from the bottom basin by the owner with a shovel.

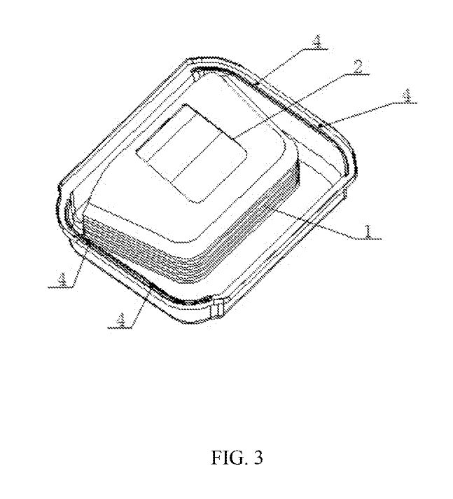

FIG. 3 is a schematic diagram of the collapsible cat litter box according to an embodiment of the present disclosure with the top cover in a collapsed (or compressed) state and placed inside the bottom basin. When the cat litter box is to be transported or not in use, the four pairs of screws 3 and nuts 5 along the cover opening of the top cover 1 and the basin opening of the bottom basin 6 are removed from the top cover 1 and the bottom basin 6, and the top cover 1 is compressed to its smallest size by collapsing the body of the top cover 1. A height of the top cover 7 is less than a width of the bottom basin 6 so that the top cover 1 is placeable inside the bottom basin 6 with the side on which the opening 2 is provided facing upward, so as to reduce the space occupied, facilitating storage and reducing transport costs.

In order to overcome the aforementioned shortcomings, one of more objects of one or more embodiments of the present disclosure is to provide a collapsible cat litter box includes a top cover and a bottom basin fixable to the top cover. The top cover can be collapsed and then placed inside a bottom basin.

In an aspect of one or more embodiments, the cat litter box further includes screws, screw-holes, and nuts for fixing the top cover to the bottom basin. The bottom basin is rectangular in shape. The top cover has a shape that matches the bottom basin and is disposed on the bottom basin. Two screw-holes are provided at each of two opposing ends of the bottom basin. One end of the top cover is provided with an opening for a cat to enter and exit.

In an aspect of one or more embodiments, a cover body of the top cover is shaped like a spring and is collapsible. Two screw-holes are provided at two opposing ends of the top cover at the cover opening. The two screw-holes of the top cover are formed at the positions corresponding to the positions of the two screw-holes provided at the two ends of the bottom basin. Therefore, the top cover can be fixed to the bottom basin by fitting the nuts onto the screws.

A user can unscrew the two screws on the two ends of the bottom basin so that the top cover is separated from the bottom basin. The user can add cat litter or replace the old cat litter stored in the bottom basin. In general, cat litter forms hard lumps when after contacting with feces and urine and the hard lumps of the cat litter may be conveniently removed from the bottom basin by the owner with a shovel. The top cover is fixed to the bottom basin by fitting the nuts onto the screws, giving a simple structure and a reliable connection. The top cover is made from a blow-molded material to save raw materials and reduce production costs.

When the cat litter box is to be transported or not being used, the four screw/nut assemblies at the top cover opening and the bottom basin opening are taken apart, the top cover is compressed to its smallest size by collapsing the cover body, and the compressed top cover is then placed inside the bottom basin with the side on which the door is provided facing upwards, so as to reduce the space occupied, facilitating storage and reducing transport costs.

The cat litter box according to one of or more embodiments provides several advantages, e.g., little space is occupied and the cost of transporting the product is reduced when the collapsed top cover is placed inside the bottom basin. At the same time, because of the simple structure, installation and dismantling are convenient.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A collapsible cat litter box, comprising:
a top cover,
a bottom basin, and
a fixing unit configured to fix the top cover to the bottom basin, wherein
the top cover includes first holes, and the bottom basin includes second holes,
the fixing unit includes screws and corresponding nuts, and
the first and second holes are configured to cooperate with the screws and nuts to fix the top cover to the bottom basin.

2. The collapsible cat litter box according to claim 1, wherein the bottom basin is formed in a rectangular shape.

3. The collapsible cat litter box according to claim 2, wherein a shape of the top cover matches the shape of the bottom basin.

4. The collapsible cat litter box according to claim 1, wherein the second holes are positioned on a periphery of the bottom basin.

5. The collapsible cat litter box according to claim 1, wherein the second holes are provided at each of two opposing ends of the bottom basin.

6. The collapsible cat litter box according to claim 1, wherein the top cover further comprises an opening for a cat to enter and exit.

7. The collapsible cat litter box according to claim 1, wherein the first holes are provided on a periphery of the top cover.

8. The collapsible cat litter box according to claim 1, wherein the first holes are provided at two ends of the top cover and positions of the first holes coincide with positions of the second holes provided at the two ends of the bottom basin.

9. The collapsible cat litter box according to claim 1, wherein the top cover is collapsible.

10. The collapsible cat litter box according to claim 9, wherein the top cover includes a body having a plurality of ridges and grooves alternatively arranged in a longitudinal direction of the top cover, and the body of the top cover is collapsible.

11. The collapsible cat litter box according to 4, wherein the bottom basin comprises a body and an edge portion defining the periphery of the bottom basin and protruding outwardly from the body.

12. The collapsible cat litter box according to claim 11, wherein the edge portion of the bottom basin is configured to receive an edge portion of the top cover when the top cover is fixed to the bottom basin.

13. The collapsible cat litter box according to claim 1, wherein the top cover is made of a blow-molded material.

14. The collapsible cat litter box according to claim 1, wherein a height of the top cover is less than a width of the bottom basin so that the top cover is placeable in the bottom basin when the top cover is collapsed in a longitudinal direction transverse to the width direction of the bottom basin.
